(19) United States
(12) Patent Application Publication
(10) Pub. No.: US 2024/0208372 A1
(43) Pub. Date: Jun. 27, 2024

(54) DRIVE DEVICE FOR ADJUSTING AN INTERIOR ASSEMBLY OF A VEHICLE

(71) Applicant: BROSE FAHRZEUGTEILE SE & CO. KOMMANDITGESELLSCHAFT, Bamberg (DE)

(72) Inventors: Christian HERRMANN, Großheirath (DE); Alex KROMER, Stegaurach (DE); Alexander CZEMPIK, Markkleeberg (DE); Florian POHL, Ebersdorf (DE); Peter HORN, Kemmern (DE); Harald KELLER, Königsfeld (DE); Alexander MÜLLER, Bischberg (DE); Markus ROSENTHAL, Bamberg (DE)

(73) Assignee: BROSE FAHRZEUGTEILE SE & CO. KOMMANDITGESELLSCHAFT, Bamberg (DE)

(21) Appl. No.: 18/022,311

(22) PCT Filed: Aug. 20, 2021
(86) PCT No.: PCT/EP2021/073174

§ 371 Date: Sep. 11, 2023

(30) Foreign Application Priority Data
Aug. 21, 2020 (DE) 10 2020 210 656.8

(51) Int. Cl. B60N 2/02

(52) U.S. Cl. CPC B60N 2/0239; B60N 2/0228; B60N 2/0252; B60N 2/0256

(57) ABSTRACT

A drive device for adjusting an interior assembly of a vehicle includes an electromotive adjustment drive configured to adjust the interior assembly and a controller configured to control the adjustment drive. The controller is further configured to control the adjustment drive in a servo operation for providing a supporting force during a manual adjustment of the interior assembly by a user.

### CROSS-REFERENCE TO RELATED APPLICATIONS

This application is the U.S. National Phase of PCT/EP2021/073174 Filed Aug. 20, 2021, which claims priority to German Application No. DE 10 2020 210 656.8 Filed Aug. 21, 2020, the entire disclosures of which are incorporated by reference herein.

### TECHNICAL FIELD

The present disclosure relates to a drive device for adjusting an interior assembly of a vehicle.

### BACKGROUND

Such a drive device comprises an electromotive adjustment drive for adjusting the interior assembly and a control device for controlling the adjustment drive.

An interior assembly of the type described here is an assembly in the interior of a vehicle. An interior assembly of the type described here can be, for example, a vehicle seat, a console element with a storage or shelf function, a monitor, a partition or a shelf such as a table or a storage compartment. The interior assembly is not part of the vehicle body and, in this respect, does not serve to close off the vehicle from the outside (as is the case with a vehicle door or sunroof). The interior assembly is also not part of a drive and steering system of the vehicle (such as, for example, a steering column of a vehicle) The interior assembly is arranged in the interior of the vehicle and is adjustable in the interior by a user, in particular to provide a comfort function in the interior.

### SUMMARY

For example, a vehicle seat may be adjustable to adjust a recline, a longitudinal and/or transverse position, or even to adjust a rotational position in the interior to provide a comfortable seating position for a vehicle occupant. For example, a console member may be slidable along a vehicle floor to provide storage in the interior of the vehicle or to allow actuation of a functional assembly on the console member. A monitor may be adjustable in its pivot position, its height position, and/or its tilt position to allow comfortable viewing of the monitor by a vehicle occupant.

Particularly in the case of new interior concepts, for example in connection with autonomous driving vehicles, interior assemblies such as vehicle seats or console elements can be variably adjustable to enable vehicle occupants to drive comfortably in the vehicle if necessary. It should be possible for a user to adjust an interior assembly easily, conveniently and intuitively.

From US 2017/0166089 A1 a vehicle seat in the interior of a vehicle is known which is electrically adjustable. The adjustment of the vehicle seat can be initiated by a user using a gesture control, for example by a user performing a predetermined gesture in the area of the vehicle seat and thereby causing, for example, a pivoting of a backrest or a longitudinal adjustment of the vehicle seat in the vehicle interior.

One object of the present disclosure is to provide a drive device for adjusting an interior assembly in a vehicle that can enable a user to adjust the interior assembly easily, conveniently, intuitively.

This task is solved by an object having the features as described below.

Accordingly, the control device is designed to control the adjustment drive in a servo operation for providing an assisting force during a manual adjustment of the interior assembly by a user.

In a conventional interior assembly, for example a vehicle seat, adjustment is performed manually by a user or electromotively using an electromotive drive device. For a manual adjustment, for example, a locking device for a longitudinal adjustment of a vehicle seat or for an inclination adjustment of a backrest can be unlocked to allow a user to move the vehicle seat, for example to adjust the longitudinal position or to adjust the inclination of the backrest. In the case of electromotive adjustment, on the other hand, a user actuates, for example, a switch for controlling an electromotive drive device, which then electromotively adjusts a vehicle seat, for example, in automatic mode or when the switch is continuously actuated by the user, in order, for example, to adjust a longitudinal position of the vehicle seat or to adjust the inclination of a backrest of the vehicle seat.

Compared to conventional adjustment concepts, according to the present disclosure the adjustment of the interior assembly (for example in the form of a vehicle seat, a console element, a monitor, a partition, a shelf, a storage compartment or the like) may basically be performed manually by a user, but with electric motor support by the drive device in a servo operation. Thus, a user does not have to provide the full force required to overcome loads acting on the interior assembly to adjust it, but only a partial force. This enables intuitive, convenient adjustment of the interior assembly by a user with electric motor assistance from the drive device. This also enables fast and variable adjustment with little force to be applied by a user. The adjustment of the interior assembly, for example of a vehicle seat, can thus be effected by a user engaging the interior assembly and thereby acting on the interior assembly to adjust it to a desired position, wherein the user only has to apply a small force to adjust it and any force required in addition is provided by the electromotive drive device.

In addition to such a servo operation, a purely electromotive adjustment can also be possible, for example in an automatic operation for adjustment between defined positions or under permanent actuation of a switch by a user.

The drive device is operated in servo operation for manual, but electric motor assisted adjustment of the interior assembly. In the servo operation, the adjustment drive is controlled, for example, in such a way that an assisting force is provided by the adjustment drive for manual adjustment of the interior assembly and, in doing so, the force to be applied by a user is, if possible, the same over the adjustment path or a part of the adjustment path of the interior assembly or follows a desired curve.

In one embodiment, the drive device has an inhibiting device for inhibiting an adjustment movement of the interior assembly in a locked position. In this case, the controller may be configured to transfer the inhibiting device from the inhibited position to a non-inhibited position in order to adjust the interior assembly.

The inhibiting device is designed to lock the interior assembly in a position it has just assumed when no adjustment of the interior assembly is to be made. The inhibition provided by the inhibiting device is to be dimensioned in such a way that the interior assembly is held in position safely and reliably when load forces occur. This includes, for example, that a vehicle seat may be held safely and reliably in position in the event of a crash, in order to prevent unacceptable uncontrolled movement of the vehicle seat in the event of a crash and thus reduce the risk of injury to a user. The inhibiting device may thus have to be designed to be crash-resistant, for example when the interior assembly is designed by a vehicle seat, so that crash forces can be absorbed and dissipated.

If, on the other hand, the interior assembly is to be adjusted, the inhibiting device may be released so that any inhibition acting on the interior assembly is lifted and the interior assembly can be adjusted manually but, if necessary, with the assistance of an electric motor during servo operation of the drive device.

The drive device can, for example, have a gearbox that is driven via the adjustment drive. The gearbox can be used, for example, to drive an output element that is operatively connected to the interior assembly, so that an adjustment force can be introduced into the interior assembly via the output element and an adjustment of the interior assembly can be effected via this. In this case, the inhibiting device can be designed, for example, by a brake which is operatively connected to the output element and (indirectly or directly) locks the output element in the locked position, so that the output element cannot be adjusted in the locked position of the locking device without further ado, at least not without lifting the inhibition, and the interior assembly operatively connected to the output element is thus held in position via the inhibiting device. If the interior assembly is to be adjusted, the inhibiting device can be released from the locked position to the unlocked position so that the output element can be adjusted.

If such an inhibition device is provided, the adjustment drive implemented by an electric motor can, in particular, not be designed to be self-locking, so that the adjustment drive itself does not lock the output element in the non-energized state and thus also does not hold the interior assembly in position. Instead, the locking of the interior assembly is performed by the inhibiting device, which locks the interior assembly in the locked position in such a way that crash forces, for example, can be absorbed safely and reliably. If the inhibiting device is released, the interior assembly can be adjusted manually by a user, whereby a supporting force is provided via the drive device in servo operation and thus the interior assembly can be adjusted by a user with comparatively little user force.

The interior assembly may, for example, be pivotable about a pivot axis and/or displaceable along a longitudinal direction. For example, if the interior assembly is configured by a vehicle seat, the vehicle seat may be displaceable as a whole along a vehicle floor, for example along a vehicle longitudinal direction and/or along a vehicle transverse direction. In addition, the vehicle seat may be rotatable about a vehicle vertical direction so that the rotational position of the vehicle seat in the vehicle interior can also be adjusted. In addition, assemblies of the vehicle seat, such as a backrest part or a seat surface, may be adjustable, for example to adapt a tilt position.

Analogous adjustability can also be provided on other interior assemblies, such as a console element. A console element can be displaceable along a vehicle floor, for example, and a height position of the console element or a rotational position can also be adjustable, if necessary. A monitor can be adjustable, for example, in its swivel position, its rotational position, its height position and its inclination.

The adjustment movements of the interior assembly as a whole or of individual (sub-) assemblies of the interior assembly can be effected by one or more drive devices, the adjustment being carried out manually by a user and supported by electric motor by a respective drive device.

In one embodiment, the interior assembly has an operating element that can be actuated by a user to adjust the interior assembly. Such an operating element can, for example, be formed by a mechanically actuated pushbutton. The operating element may be arranged directly on the interior assembly, but may also be spatially remote from the interior assembly if necessary, but associated with the interior assembly. An adjustment process can be initiated by a user pressing the operating element, for example, and then adjusting the interior assembly manually, but with the assistance of an electric motor in servo operation of the drive device. It is conceivable that a user may actuate the operating element continuously during an adjustment process and that the interior assembly can be adjusted until actuation of the operating element is terminated. However, it is also conceivable that the user only has to actuate the operating element once, thereby starting an adjustment mode in which servo-assisted adjustment of the interior assembly is possible.

In addition or as an alternative to such an operating element, the interior assembly can have a sensor device for detecting a touch, an approach, an acceleration and/or a speed of movement on the interior assembly, the control device being designed to evaluate a detection signal from the sensor device for detecting a user's adjustment request.

If the sensor device is designed to detect a touch, the sensor device is realized, for example, by a tactile touch sensor, such as a pressure sensor or the like.

If the sensor device is configured to detect a proximity, the sensor device is implemented by a proximity sensor, for example a capacitive sensor, which can detect a proximity of a user, for example a body part such as a user's hand, to generate a detection signal upon proximity.

A sensor device in the form of a touch sensor or a proximity sensor can in particular detect a user's touching of the interior assembly in a specific area, for example in the area of a backrest. If, for example, a user places his hand on an area of the interior assembly associated with the sensor device, for example the backrest of a vehicle, this can be interpreted as an adjustment request to enable a user to adjust the interior assembly.

If the sensor device is designed to detect an acceleration on the interior assembly, the sensor device can, for example, be designed as an acceleration sensor arranged on the interior assembly, which outputs a measurement signal dependent on an acceleration of the interior assembly.

If the sensor device is designed to detect a speed of movement on the interior assembly, the sensor device is designed, for example, by a gyro sensor, which can in particular detect a rotational movement of an interior assembly.

The sensor device, for example in the form of a proximity sensor, a touch sensor, an acceleration sensor or a speed sensor, can also be used, for example, to provide a further function on the interior assembly, for example for the purpose of obstacle detection, collision protection or anti-trap protection.

Additionally or alternatively, an interior monitoring device—for example in the form of a camera, a radar system or a lidar system—can be provided, by means of which a movement of a user in the interior of the vehicle can be detected. A detection signal from the interior monitoring device can be evaluated by the control device to detect a user's wish to adjust the seat.

An interior monitoring device can be used, for example, to define and monitor a virtual operating surface in the area of the interior assembly. If the interior monitoring device detects that a user is touching the virtual control surface, this can be interpreted as a request for adjustment in order to initiate adjustment of the interior assembly.

A movement of a part of a user's body can be detected here, for example, by imaging processes and image-based evaluation of detected signals. For example, images from a camera can be evaluated to detect and interpret a user movement.

The interior monitoring device can also be used—in the same way as the sensor device—to provide a further function on the interior assembly, for example for the purpose of obstacle detection, collision protection or anti-trap protection.

Several (different) sensor devices and/or a monitoring device can be combined with each other, if necessary, in order to evaluate detection signals from the different devices in a combined manner, in particular for detecting an adjustment request.

In general, a user's wish for adjustment may be distinguished from situations in which no adjustment is to take place. For example, a certain movement of a user may indicate a request for adjustment, while in other situations, for example when vehicle occupants are in the vehicle interior while the vehicle is in motion, no adjustment of the interior assembly is to take place. A signal detected by a sensor device or an interior monitoring device is thus to be evaluated in order to distinguish, in particular, an operation by a user to adjust the interior assembly from, for example, a movement by the user or another object in the vehicle interior that does not correspond to an adjustment request.

For example, a predetermined user gesture may be required to initiate an adjustment process. Accordingly, in one embodiment, the control device can be designed to evaluate a detection signal from a sensor device or an interior monitoring device for detecting a predetermined gesture, in order to conclude an adjustment request when the predetermined gesture is detected. If the sensor device is designed as a capacitive sensor, for example, or if an interior monitoring device is used, the sensor device or the interior monitoring device can be used to detect a predetermined gesture of a user, for example a movement of a body part with a specific movement pattern, for example a movement in a specific direction in the area of the interior assembly and/or with a specific movement speed.

For example, to initiate an adjustment process of the interior assembly, it may be provided that a user acts on the interior assembly with his hand with a certain pattern. For example, it may be provided that the user taps the interior assembly with his flat hand a predetermined number of times, for example twice, which is detected by one or more sensor devices and/or the interior monitoring device and interpreted as an adjustment request. Additionally or alternatively, it may be provided that the user taps the interior assembly in a certain manner, thereby triggering, for example, a plurality of sensor devices to signal an adjustment request.

In addition or alternatively, an adjustment mode can be started, for example, via a central operating element in a vehicle, for example via an on-board computer on a center console, via a communication device such as a cell phone or the like.

An adjustment mode within which adjustment of the interior assembly in a servo-assisted manner by a user is possible can be terminated after a predetermined time, for example. Alternatively, an adjustment mode termination may be terminated after a predetermined time following an adjustment action. Again alternatively, a termination of the adjustment mode may be terminated after a termination of an operation of an operating element. Again alternatively, termination of the adjustment mode may also be effected by active actuation of an operating element, for example by switching off a switch.

When the adjustment mode is terminated, an inhibiting device that was released when the adjustment mode was initiated can, for example, be transferred back to the locked position so that the associated interior assembly is locked and cannot be adjusted any further.

During a transition from the servo operation to a (again) locked position of the interior assembly, a position control can take place in an intermediate state for (electromotive) holding of the interior assembly in the position just assumed. In servo operation, a user manually adjusts a respective interior assembly with electromotive servo support of the adjustment, and after completion of the adjustment, the drive device is switched to a holding mode in which the interior assembly is held in position, for example with current, by controlling the adjustment drive. Subsequently, for example, the inhibiting device is switched to the locked position so that the interior assembly is locked without current and held in position.

In one embodiment, the control device is designed to activate the adjustment mode for adjusting the interior assembly in servo operation depending on at least one trigger criterion. In general, the servo operation is not always provided, for example, so that adjustment of the interior assembly is not always possible, but only in certain situations. For this purpose, the control device evaluates one or more trigger criteria in order to determine, depending on the trigger criteria, whether the adjustment mode for providing the servo operation should be activated or not.

By starting the adjustment mode to provide servo operation in response to one or more trigger criteria, it may be possible to simplify a sensor system for initiating servo operation and detecting a request for adjustment. For example, when the adjustment mode is activated, an inhibition device can be unlocked so that the drive device for adjusting the interior assembly is placed in such a state that adjustment is possible manually by a user. Once the adjustment mode has been started, a user can, for example, engage the interior assembly and move it, whereby such a movement can be detected in a simple manner on the basis of the adjustment movement of the interior assembly, in order to then initiate the actual servo operation for servo-assisted adjustment of the interior assembly and to provide a motor force in servo operation which supports the adjustment of the interior assembly in an electromotive manner.

A trigger criterion may, for example, be an occupancy state of the interior assembly. If the interior assembly is, for example, a vehicle seat or an assembly of a vehicle seat, for example the backrest of a vehicle seat, the control device only makes the adjustment mode available for adjustment in servo operation, for example, if the vehicle seat is not occupied by a vehicle occupant. For example, the backrest should only be adjustable when the vehicle seat is empty. The occupancy status can be evaluated here, for example, on the basis of a (capacitive) occupancy sensor, on the basis of the status of a seat belt buckle or also by an interior monitoring device.

Another trigger criterion may be the opening state of a vehicle door, in particular a vehicle side door or a tailgate. For example, the control device can be designed to activate the adjustment mode for providing servo operation as soon as a vehicle side door is opened. For example, if the right, rear vehicle side door is opened, the adjustment mode for providing servo operation for a vehicle seat at the right rear and/or right front can be started. If, on the other hand, the left rear vehicle side door is opened, for example, the adjustment mode for providing servo operation for a left rear and/or left front vehicle seat is started. If it is determined that the tailgate is opened, the adjustment mode can be started for a rear row of seats in a vehicle, for example.

As an additional criterion, a driving state of the vehicle can be evaluated. For example, the adjustment mode can only be possible when the vehicle is stationary. Alternatively, the adjustment mode can be activated when the vehicle is stationary or, if necessary, when the vehicle is moving. When the vehicle is moving, the adjustment mode can be prevented depending on the situation, for example depending on the speed at which the vehicle is moving or in the event of a so-called “precrash” warning, which indicates a possible impending crash. If the drive device is currently in adjustment mode during such a “precrash” warning, the adjustment mode can be switched off and the interior assembly can be locked in the position it has just assumed in order to absorb and dissipate crash forces if necessary.

In one embodiment, the control device is configured to trigger the adjustment drive with a pulse-width modulated current signal upon or after activation of the adjustment mode. If the adjustment mode is started as a function of one or more trigger criteria, an inhibiting device is unlocked, for example, and thus the interior assembly is brought out of a locked, fixed position into a state in which it is possible to move the interior assembly. At the start of the adjustment mode, the control device controls the adjustment drive with a pulse-width modulated signal in such a way that, for example, the interior assembly is held in position by the adjustment drive by means of an electric motor and thus, for example, the effect of gravity is compensated.

In one embodiment, the pulse-width modulated current signal can be applied at such a low energy level that the interior assembly does not yet move. Alternatively, the current can be applied in such a way that the actuator and correspondingly also the interior assembly begin to move, for example, slowly in a direction of movement. If a user grips the interior assembly and adjusts it manually, the actual servo assistance in servo operation is provided by the fact that a supporting force is made available by the adjustment drive to support the adjustment movement.

The pulse width modulated current supply at the start of the adjustment mode can, for example, take place in such a way that the adjustment drive is alternately supplied with current in one and the other direction of movement, for example for a predetermined period of time in one direction and for the same period of time or a different period of time in the other direction. The pulse width modulated current signal can differ in its power depending on the direction of movement.

The power of a pulse width modulated current signal can be predefined as a parameter, can be calibrated and predefined during production, or can be adaptively defined for each adjustment process, i.e. when the adjustment mode is activated.

In one embodiment, the control device is configured to control the adjustment drive in the adjustment mode for providing a supporting force during a manual adjustment of the interior assembly by a user, if an adjustment request of a user is detected after activation of the adjustment mode. If the drive device has been switched to the adjustment mode in which, for example, an inhibiting device is unlocked and, in addition, the adjustment drive is initially energized with a pulse-width modulated energization signal, the servo-assisted adjustment takes place as soon as it is detected that a user is moving the interior assembly. Such a movement can be detected, for example, by means of a sensor system on the interior assembly, for example by an arrangement of Hall sensors or the like.

Alternatively to starting the servo assisted adjustment in servo operation operation based on a simple motion detection of the interior assembly, in another embodiment, the servo operation is only started when a predetermined user event is identified. For example, servo assistance in servo operation is not initiated until, for example, a shaking motion is detected on the vehicle seat, with a motion interval, for example, different from a powering interval or in time with the powering interval (in the case of alternating powering in different motion directions). In another example, servo assistance is initiated in servo operation when a predetermined pulse force, in the sense of a nudge, is detected at the interior assembly.

In one embodiment, the control device is adapted to generate an indication signal indicating the adjustment mode for output to a user after the adjustment mode has been activated. For example, the control device may generate an indication signal to be output via a vehicle device, such as an audio system of the vehicle, to indicate to the user that the adjustment mode has been started for adjustment. Alternatively, the indication signal may comprise the control device actuating the adjustment drive to move the interior assembly, for example, at a slow speed of movement or by generating a vibrating movement on the interior assembly in a manner perceptible to the user. Again alternatively, the control device may, for example, generate and deliver to the adjustment drive such a modulated energization signal that the adjustment drive is stimulated to generate a predetermined sound, for example music. The actuator drive is thus energized in such a way that a signal in the audible range is generated at the actuator drive.

The variable speed drive can, for example, be designed as a DC motor, particularly advantageously as a brushless DC motor.

The control device can be integrated into the actuator, but can also be designed separately from the actuator, for example by a seat control unit or a central control unit in the vehicle.

In one embodiment, the control device comprises a servo control module for determining a setpoint value depending on a load acting on the interior assembly. The control device may also include, for example, a current control module for controlling a current of the actuator, the current control module being adapted to control the current of the actuator based on the setpoint supplied by the servo control module.

Accordingly, in servo operation, current control of the drive device takes place, with a setpoint generated by the servo control module being fed to a current control module and current control taking place in the current control module on the basis of the setpoint received from the current control module. In this case, the servo-control module is designed to set the setpoint value in such a way that the force provided by the adjustment drive supports the user in moving the interior assembly in such a way that the force to be applied by the user is, as far as possible, at least approximately the same (or follows a desired curve) and thus results in a comfortable, haptically pleasant adjustment of the interior assembly for the user.

In one embodiment, the control device additionally has a load calculation module that is connected upstream of the servo control module and is used to determine a load acting on the interior assembly. The load is a force acting on the interior assembly independently of an applied user force, which can in particular counteract an adjustment of the interior assembly (or, if necessary, also support the movement of the interior assembly) and depend, for example, on the vehicle position, an adjustment direction of the interior assembly and a current adjustment position of the interior assembly.

The load calculation module can be designed in particular to determine a static and/or dynamic load acting on the interior assembly. The load can be determined, for example, as a function of an angle of inclination of the vehicle measured about a longitudinal vehicle axis, an angle of inclination of a pivot axis of the interior assembly measured about the longitudinal vehicle axis, an angle of inclination of the vehicle measured about a transverse vehicle axis, an angle of inclination of the pivot axis of the interior assembly measured about the transverse vehicle axis, and/or an opening angle of the interior assembly.

Depending on the inclination of the vehicle (measured around the longitudinal axis of the vehicle, also referred to as roll angle) and/or depending on the inclination of the vehicle (measured around the transverse axis of the vehicle, also referred to as slope angle), gravitational forces act on the interior assembly. Such gravitational forces can act, for example, in the direction of a desired adjustment movement or in the opposite direction to the adjustment movement. For example, if gravity acts in opposition to adjustment, a user may work against a force acting on the interior assembly due to gravity when adjusting the interior assembly wherein the supporting force provided by the adjustment drive may be adjusted so that the force to be applied by the user remains the same or follows a desired curve regardless of the position of the vehicle and the position of the interior assembly. The supporting force to be provided by the adjustment drive thus changes with the position of the vehicle and the position and adjustment direction of the interior assembly and is accordingly specified in such a way that an at least approximately constant adjustment force results for a user in servo operation.

In addition, frictional forces can act on the interior assembly, which can also be included by the load calculation module to calculate the load acting on the interior assembly.

In one embodiment, the servo control module is designed to determine a target force to be provided by the adjustment drive based on the load acting on the interior assembly as calculated by the load calculation module and supplied to the servo control module, and additionally based on a target force value to be applied by a user. The target force value corresponds to the desired force to be applied by a user when adjusting the interior assembly. The servo-control module is intended to specify the setpoint value for the current control in such a way that the adjustment drive provides a force that supports the user in adjusting the interior assembly in such a way that the user only has to apply a user force that at least approximately corresponds to the target force value.

The load calculated by the load calculation module can have a static component and a dynamic component. Thus, the load can be determined based on a static load force acting on the interior assembly and a dynamic load force acting on the interior assembly. The static load force can result from force components that result from the effect of gravity on the interior assembly as a function of the inclination angle and the slope angle of the vehicle and additionally from a frictional force acting on the interior assembly, in particular in the adjustment mechanism. The dynamic load force, on the other hand, can result from inertial forces, for example, and is thus measured on the basis of the inertia of the interior assembly and an acceleration of the interior assembly.

If the static load force and the dynamic load force are known, the target force to be provided by the variable speed drive can be calculated using a force balance as follows

Fₛₑₜ=Fₛₜₐₜ+F_{dyn}−Fᵤₛₑᵣ,

where Fₛₑₜ is the nominal force, Fₛₜₐₜ the static load force, F_{dyn} the dynamic load force and Fᵤₛₑᵣ the user force. The static load force and the dynamic load force are included positively in the force balance. The user force, on the other hand, is positive or negative depending on the direction of movement. The target force indicates the force to be provided by the adjustment drive, which corresponds to the total force required to adjust the interior assembly minus the user force.

Based on the setpoint force, the servo control module then determines the setpoint value, in one embodiment, and feeds this setpoint value to the current control module in servo operation. In the current control module, current control takes place based on the setpoint provided by the servo control module.

In one embodiment, the current control module is designed to adjust the current of the variable speed drive using pulse width modulation. In the current control module, current control takes place on the basis of the setpoint value supplied in each case, which depends on the operating mode. The current control module outputs a manipulated variable which is used to set the voltage supplied to the variable speed drive using high-frequency pulse width modulation, for example with a frequency between 5 kHz and 100 kHz or even higher.

In the current control module, control is performed on the basis of the setpoint value supplied and the resulting actual motor current. The current of the variable speed drive is thus adjusted by control so that it corresponds to the setpoint value.

The electromotive support of the manual adjustment of the interior assembly in servo operation mode by means of current control allows the force to be applied by a user to be set to a desired target force value, whereby the control can take place in such a way that the force to be applied by the user remains at least approximately the same over the adjustment path of the interior assembly or follows a desired curve. Manual adjustment of the interior assembly in servo operation by a user can thus be performed easily, comfortably and haptically pleasantly.

In the servo operation mode, the provision of the supporting force follows the movement of a user, whereby in particular an undesired run-on, i.e. a further adjustment after the end of a user actuation, can be avoided. The user is free to choose the adjustment speed. The adjustment drive merely provides a supporting force that is variably adjusted by a user depending on the adjustment movement of the interior assembly.

In servo operation, one or more adjustment levels of one or more interior assemblies can be adjusted simultaneously. For example, self-locking can be released on a vehicle seat for one or more drive devices at the same time and an adjustment process can be initiated in servo operation, for example to move and rotate the vehicle seat longitudinally at the same time—in one motion sequence. This enables convenient, rapid, intuitive adjustment of interior assemblies by a user.

The adjustment drive of the door drive device can be a brushless DC motor (BLDC motor), for example. In principle, however, other motors can also be used.

Different applications for a drive device of the type described are conceivable and possible.

In one application, the interior assembly may be realized, for example, by a vehicle seat. In this case, the drive device can be designed in particular for adjusting a backrest of the vehicle seat relative to a seat part of the vehicle seat. In particular, the drive device can support manual pivoting of the backrest relative to the seat part by means of an electric motor in a servo operation.

In this case, the drive device is designed in particular to support pivoting of the backrest from a pivoted position into an (approximately upright) normal position of use by means of an electric motor in a servo operation. The uprighting of the backrest is thus supported by an electric motor. In contrast, for example, forward pivoting of the backrest from the upright position into the pivoted position can be performed manually without electromotive support by the drive device, but alternatively also with electromotive support in servo operation.

In another application, the interior assembly can be implemented by a vehicle seat that can be adjusted to provide an easy-entry function for easier access for a row of seats located behind the vehicle seat. In this case, the drive device can be designed to support a seat adjustment for providing the easy entry function by means of an electric motor in a servo operation. To provide the easy-entry function, the vehicle seat can, for example, be swiveled as a whole about a swivel axis, with a locking device for locking the vehicle seat to a floor assembly being unlocked for swiveling and then, after the locking device is released, the vehicle seat with its seat part and the backrest arranged thereon being swiveled about the swivel axis.

In addition, the backrest can be pivoted relative to the seat section as part of the easy entry function, whereby different adjustment drives can be provided for adjustment of the vehicle seat as a whole with electric motor assistance and for adjustment of the backrest relative to the seat section with electric motor assistance, but the adjustment can alternatively also take place in a positively coupled manner as part of an overall kinematic system and is supported by a single adjustment drive with electric motor assistance.

For example, the drive device for electric motor-assisted adjustment of a vehicle seat for providing an easy-entry function for a vehicle seat with kinematics can be designed as described in DE 10 2017 215 929 A1.

### BRIEF DESCRIPTION OF THE DRAWINGS

The idea underlying the disclosure will be explained in more detail below with reference to the embodiments shown in the figures. They show:

FIG. 1 a schematic view of a vehicle with interior assemblies in the form of vehicle seats;

FIG. 2 a schematic top view of a vehicle;

FIG. 3A a view illustrating a slope angle of a vehicle;

FIG. 3B a view illustrating a tilt angle of a vehicle;

FIG. 4 a functional view of a control device of a drive device;

FIG. 5 a graphical view of an adjustment force to be applied by a user over an adjustment path of an interior assembly in a servo operation mode;

FIG. 6 a schematic view of a drive device for adjusting an interior assembly, for example a vehicle seat;

FIG. 7 a schematic view of a vehicle seat with sensor devices arranged thereon and an interior monitoring device;

FIG. 8 a schematic view of an interior assembly in the form of a vehicle seat, designed for electric motor-assisted adjustment of a backrest relative to a seat part of the vehicle seat;

FIG. 9A a schematic view of an interior assembly in the form of a vehicle seat configured for electric motor-assisted adjustment of the vehicle seat to provide an easy-entry function; and

FIG. 9B the interior assemblies shown in FIG. 9A, in an adjusted position.

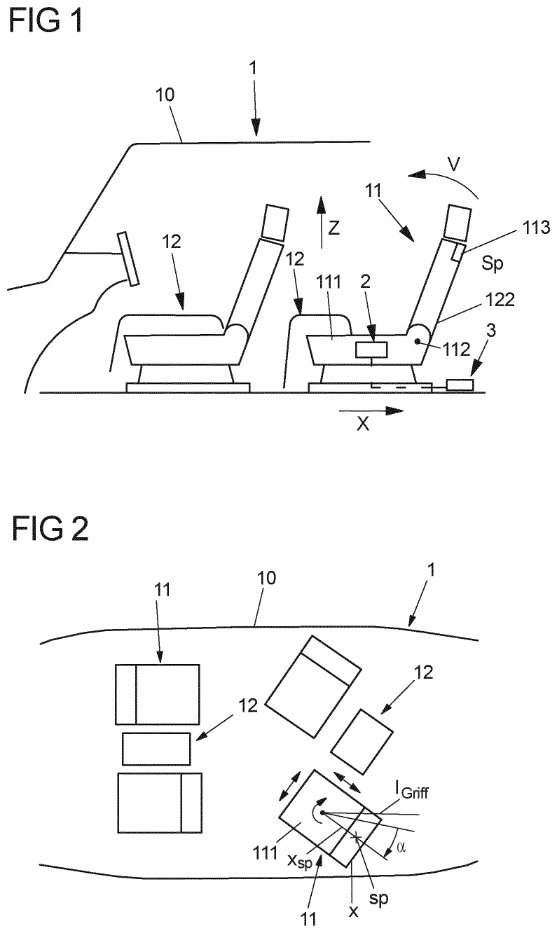

FIG. 1 shows a schematic view of a vehicle 1 which forms an interior enclosed by a vehicle body 10, in which various interior assemblies are arranged, for example in the form of vehicle seats 11 and console elements 12, and in addition possibly further interior assemblies such as, for example, monitors, partitions, shelves, storage compartments or the like.

In the context of new interior concepts, for example in connection with autonomous driving vehicles, interior assemblies 11, 12 can be adjustable in a variable manner in the interior of a vehicle 1.

For example, an interior assembly 11 in the form of a vehicle seat may be adjustable in a variable manner to adjust the vehicle seat along an adjustment plane defined by a longitudinal direction X of the vehicle and a transverse direction Y of the vehicle, and also to rotate the vehicle seat about a vertical direction Z if necessary, as can be seen from FIG. 1 when viewed together with FIG. 2. In addition, assemblies of the vehicle seat, for example the backrest 112, may be adjustable to adjust the position of the respective assembly. For example, the backrest 112 may be adjustable in its inclination. In addition, the seat assembly 111 may be adjustable in its height position and also in its tilt position.

In the case of an interior assembly 11, 12, there is a fundamental desire for convenient, intuitive, haptically pleasant adjustment by a user. If possible, the user should be able to adjust the interior quickly and precisely, and the amount of force required for this should be limited.

As shown schematically in FIG. 1, a drive device 2 is provided for adjusting an interior assembly 11, 12, which is connected to a control device 3. The drive device 2 is designed as an electric motor and can be operated to move an associated interior assembly 11, 12 between different positions by means of an electric motor.

In principle, each interior assembly 11, 12 to be adjusted or a subassembly of an interior assembly 11, 12 to be adjusted, for example the backrest 112 of a vehicle seat, can be assigned its own electromotive drive device 2, wherein the drive devices 2 can be connected to a common control device 3, for example, so that the control device 3 jointly controls the drive devices 2 for adjusting the assigned interior assembly and 11, 12.

Using the drive device 2, an associated interior assembly 11, 12 can be adjusted along a defined movement path. For example, a vehicle seat can be displaced along the vehicle longitudinal direction X along a movement path defined by guide rails relative to a vehicle floor. A backrest part 112 may also be pivotable about a defined pivot axis 110 relative to the seat part 111.

However, it is also conceivable that an interior assembly 11, 12 can be moved freely along a vehicle floor of the vehicle 1 and can thus be freely adjusted in the interior and, for example, locked at defined anchor points in the interior. In this respect, it is not mandatory to provide, for example, guide rails for defining a fixed, predetermined path of movement.

One (each) drive device 2 can, for example, be operated in an automatic mode and a servo operation and can thus effect automatic adjustment of the respectively assigned interior assembly 11, 12 or manual adjustment of the interior assembly 11, 12 by a user, but supported by the drive device 2 by means of an electric motor. For this purpose, the drive device 2 can, for example, be switchable between different operating modes, with the adjustment drive 20 being controlled in different ways depending on the operating mode set in each case.

Whereas in automatic mode a control is to be effected, for example, to a predetermined rotational speed in order to move the interior assembly 11, 12 between different positions at a predetermined adjustment speed, in servo operation a force is to be provided by the adjustment drive 20 which causes a user force to be additionally applied by a user to adjust the interior assembly 11, 12. The user force to be applied by the user may be at least approximately the same over the adjustment path of the interior assembly 11, 12 or follow a desired curve in order to allow the user a comfortable, haptically pleasant adjustment.

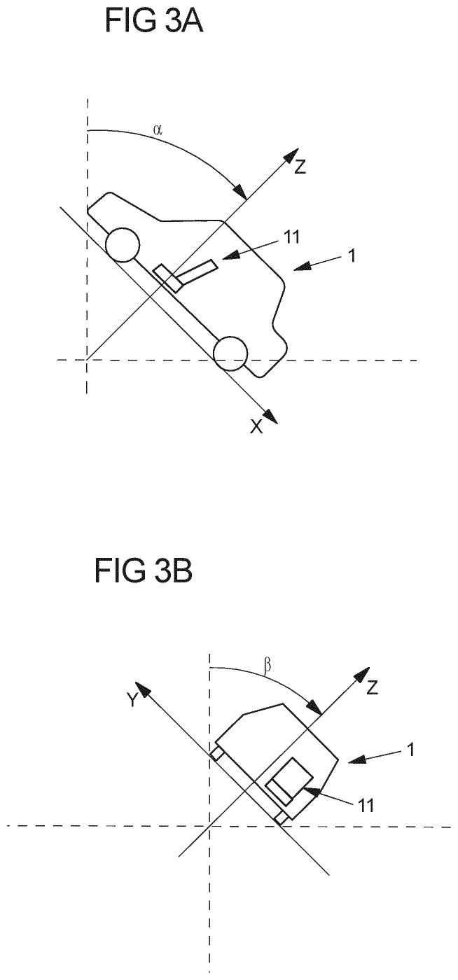

FIGS. 3A and 3B show (in representations exaggerated for illustrative purposes) different vehicle positions and resulting positions of an interior assembly 11 in the form of a vehicle seat inside the vehicle 1.

FIG. 3A shows a vehicle 1 that is parked on a slope with an incline, for example, and accordingly has an angle of slope α□ between the vehicle's vertical axis Z and a vertical line (determined by the direction of gravity). The slope angle α of the vehicle 1 is measured about the vehicle transverse axis Y (see FIG. 2B).

In contrast, FIG. 3B shows a vehicle 1 that is inclined about the vehicle longitudinal axis X (see FIG. 3A). In this case, the vehicle vertical axis Z has an angle of inclination □□β□ to the vertical measured around the longitudinal axis X of the vehicle.

As will be explained below, the vehicle position is included in the calculation of the force to be provided by the actuator 20 in the servo operation mode to assist a user in adjusting the interior assembly 11, 12.

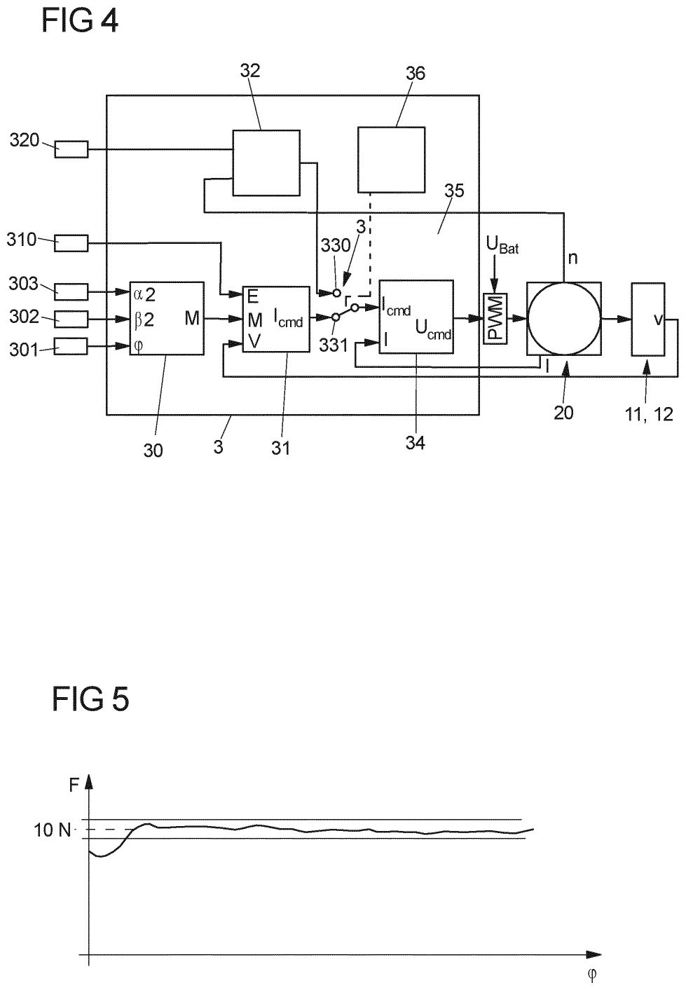

A controller (i.e. control device) 3 shown in FIG. 4 in an embodiment example for controlling the adjustment drive 20 of the drive device 2 has different control modules which, depending on the operating mode, serve to adjust a current (corresponding to the motor current) of the adjustment drive 20 designed as an electric motor in such a way that an adjustment of an interior assembly 11, 12 takes place in a desired manner depending on the operating mode, namely in automatic mode with a desired adjustment speed and in servo operation in a force-supported manner.

The control device 3 implements a current control module 34, to which a setpoint I_{cmd} is supplied, whereby, depending on the operating mode, the current control module 34 receives the setpoint I_{cmd} from a speed control module 32 or a servo control module 31.

The speed control module 32 is used in this case to specify the setpoint I_{cmd} in an automatic mode in such a way that a desired speed results at the variable speed drive 20 and correspondingly a desired variable speed v at the interior assembly 11, 12.

In contrast, the servo control module 31 serves to specify the setpoint I_{cmd} in such a way that a manual adjustment of the interior assembly 11, 12 is supported in servo operation with a force that is set in such a way that the additional force to be applied by a user may be at least approximately the same over the adjustment path of the interior assembly 11, 12 or follows a desired curve.

The speed control module 32 controls the speed of the variable speed drive 20 in automatic mode. A setpoint speed n_{cmd} is fed to the speed control module 32 via an input 320, whereby the setpoint speed n_{cmd} is stored in a memory, for example, and is thus fixed (as a constant value or as a speed curve over the adjustment path), but can also be adapted by a user if necessary. Depending on the setpoint speed n_{cmd} and the speed actually occurring at the variable speed drive 20 in closed-loop operation, the speed control module 32 determines a setpoint value I_{cmd}, which it supplies to the current control module 34.

In automatic mode, the speed control module 32 is connected to the current control module 34 via a switching device 33 by switching the switching device 33 to a switching point 330. The setpoint I_{cmd} output from the speed control module 32 is thus supplied to the current control module 34, so that the current control module 34 can perform current control based on the setpoint I_{cmd} received from the speed control module 32.

The switching device 33 can be physically implemented by a mechanical switch. Advantageously, however, the switching device 33 is implemented in software terms by the software of the control device 3. Likewise, the modules of the control device 3 are may be implemented by software modules.

The switching device 33 is controlled, for example, via a control module 36 of the control device 3.

Current control is performed in the current control module 34. The current control module 34 controls the current of the variable speed drive 20 such that it is set to the setpoint value 34 supplied to the current control module 34. The current control module 34 adjusts the current using a voltage set point U_{cmd} in the form of a load factor (between 0% and 100%) by supplying the voltage set point U_{cmd} to a pulse width modulation 35, which generates an output voltage based on the vehicle battery voltage U_{Bat} and the voltage set point U_{cmd} and supplies it to the adjustment drive 20. The pulse width modulation 35 may operate at a comparatively high frequency, in particular at a frequency between 5 kHz and 30 kHz, for example 20 KHz. Based on the setpoint I_{cmd} and the actual resulting current I of the actuator 21, the control value U_{cmd} is adjusted so that the motor current I is regulated to the setpoint I_{cmd}.

In automatic mode, control thus takes place in the form of cascade control, in which the speed control module 32 determines an actuating value in the form of a setpoint I_{cmd} and supplies it to the downstream current control module 34 for current control.

By switching the switching device 33 to the switching point 331, it is possible to switch to a servo operation in which a setpoint I_{cmd} is now supplied to the current control module 34 from the servo control module 31, but not from the speed control module 32. On the basis of the setpoint value received from the servo-control module 31, current control is then performed in such a way that the force provided by the adjustment drive 20 assists a user in adjusting the interior assembly 11, 12 and the user has to apply a user force that may be largely uniform over the adjustment path of the interior assembly 11, 12 for the electromotively assisted adjustment of the interior assembly 11, 12.

Determination of the setpoint I_{cmd} by the servo control module 31 is performed as a function of a load acting on the interior assembly 11, 12, which is calculated by a load calculation module 30 as a function of the vehicle position and, for example, a position of the interior assembly 11, 12.

This can be explained, for example, by means of an adjustment in the form of a rotary movement about the vehicle vertical axis Z of an interior assembly 11, 12 in the form of a vehicle seat. Such a rotary movement results in loads on the interior assembly 11, 12 influenced by the vehicle inclination and the vehicle slope, which are taken into account when determining the setpoint I_{cmd}.

The load acting on the interior assembly 11, 12 is basically determined by a static load force and a dynamic load force.

For a rotation about the vehicle vertical axis Z, a static load torque acting on the interior assembly 11, 12 is determined in particular on the basis of a torque resulting from gravity about the vehicle vertical axis Z and additionally on the basis of a frictional torque acting in the bearing of the interior assembly 11. The static torque, referred to as the static load torque, is thus obtained as follows

Mₛₜₐₜ=M_{inclination}*cos(α)+Mₛₗₒₚₑ±M_{R},

where Mₛₜₐₜ denotes the static load moment, M_{inclination} denotes an inclination moment resulting due to a vehicle inclination, Mₛₗₒₚₑ denotes an slope moment resulting due to a vehicle slope, and M_{R} denotes a friction moment in the bearing of the interior assembly 11, 12.

It should be noted that the term “cos □α)” in the above equation is only present if the inclination/slope angles are determined according to DIN ISO 8855 (corresponding to the Euler angle, which results from a roll angle, slope angle and yaw angle). If the inclination angle is measured (absolute), the term “cos □α)” is omitted.

The slope moment and the inclination moment are calculated as follows:

Mₛₗₒₚₑ=xₛₚ*m*g*sin(α)*sin(φ)

M_{inclination}=xₛₚ*m*g*sin(β)*cos(φ)

The values used in these equations represent:
φ current rotation angle [° ]—Offset angle
x_{SP} distance center of gravity—rotation axis [m]
m mass of interior assembly group [kg]
g gravity accelartaion [m/s²]
α slope rotation axis
β inclination rotation axis [° ]
M_{R} friction moment [Nm]

The angles α, β are □ illustrated in FIGS. 3A and 3B. The distance x_{SP} between the center of gravity SP of the interior assembly 11 and the axis of rotation of the interior assembly 11, 12 is drawn in FIG. 2 as an example. The slope of the vehicle 1 and the inclination of the vehicle 1 as well as the current position of the interior assembly 11, 12 can be sensed by sensors 301, 302, 303, and accordingly measured values are fed to the load calculation module 30.

When determining the static load moment, an occupancy by a user or by objects can also be taken into account—for example when the interior assembly 11, 12 is designed as a vehicle seat. In this case, the mass of the interior assembly 11, 12 changes in particular. A force acting due to an occupancy can, for example, be determined at least approximately on the basis of a sensor signal of a sensor device of the interior assembly 11, 12 and included in the calculation of the load torque.

In addition to the static load moment, a dynamic load moment acts when the interior assembly 11, 12 moves, which is calculated as follows:

M_{dyn}=\ddot{φ}*I*c

\ddot{φ}denotes the acceleration of interior assembly 11, 12. The acceleration of the interior assembly 11, 12 can be determined from a change in the adjustment angle □□ about the axis of rotation. Alternatively, however, the acceleration can also be calculated from the adjustment speed v of the interior assembly 11, 12 that is supplied to the servo control module 31 during operation.

In the above equation, I stands for the inertia of the interior assembly 11. The factor c enables dynamic haptics to be set and can assume values between 0% and 100%. When c=100%, a change in dynamic response to acceleration of the interior assembly 11 is essentially compensated for by the motor. If c=0%, a user may apply a change in force himself during acceleration.

In addition to such static and dynamic load forces, there is a torque on the interior assembly 11, 12 caused by the user force at the point of application on the interior assembly 11, 12. The user torque in this case is given by

Mᵤₛₑᵣ=Fᵤₛₑᵣ*I_{grip}

with
Fᵤₛₑᵣ desired operation force [N]
I_{Grip} distance engagement position—pivotal axis [m]
Mᵤₛₑᵣ moment generated by user [Nm]

The distance I_{Grip} between an engagement position at which a user engages an interior assembly 11, 12 as intended and which can correspond, for example, to the position of an operating element on the interior assembly 11, 12, and the axis of rotation of the interior assembly 11, 12 pointing along the vehicle vertical direction Z is shown schematically in FIG. 2.

Based on the static load torque, the dynamic load torque and the user torque, a force balance in the form of a torque balance can be established to determine a target load torque to be provided by the variable speed drive 20. The moment balance is calculated as follows:

Mₛₑₜ=Mₛₜₐₜ+M_{dyn}−Mᵤₛₑᵣ

Mₛₑₜ denotes the torque to be provided by the drive device 2 at the rotary axis. From this, the servo-control module 31 calculates the torque to be provided by the positioning drive 20, taking into account a transmission ratio of the drive device 2 to

M_{set_drive}=Mₛₑₜ*Üₗₑᵥₑᵣ

Ülever designates the transmission ratio of the kinematics of the drive device 2 for translating an adjustment force provided by the drive device 2 at the location of an electromotive adjustment drive into an adjustment force at the location of the rotational axis of the interior assembly 11, 12. Ülever can be dependend on ϕ and can be stored in the system, for example, in the form of a look-up table.

The setpoint torque of the electromotive variable speed drive is calculated from the setpoint torque of the actuator, taking into account the motor efficiency and a transmission ratio of a motor gearbox to

$${M}_{Set\_motor} = \frac{{M}_{Set\_drive}}{{η}_{motor} * {\ddot{u}}_{gear}}$$

$$with$$

$$\begin{matrix}{η}_{motor} & transmission efficiency [ ] \\ {\ddot{u}}_{gear} & gear transmission [ ]\end{matrix}$$

The motor current is basically proportional to the motor torque, so that the setpoint value can be calculated from the setpoint motor torque M_{set_motor} as follows:

$${I}_{set\_motor} = \frac{{M}_{Set\_motor}}{Kt} + {I}_{o}$$

$$with$$

$$\begin{matrix}{K}_{t} & Motor constant [ Nm / A ] \\ {I}_{o} & Motor idle current [ A ]\end{matrix}$$

This value is supplied as the setpoint I_{cmd} from the servo control module 31 to the current control module 34 in servo operation mode.

For another adjustment, for example for a longitudinal and/or transverse adjustment of an interior assembly 11, 12 along a vehicle floor, i.e. along an adjustment plane spanned by the vehicle longitudinal direction X and the vehicle transverse direction Y, a similar system of equations results in which the load on the interior assembly 11, 12 depends on the inclination and slope of the vehicle 1, as shown in FIGS. 3A and 3B.

In servo operation mode, the setpoint I_{cmd} is thus determined by taking into account load forces acting on the interior assembly 11, 12 in such a way that a force to be applied by the user over the adjustment path of the interior assembly 11 is the same or follows a desired curve. Accordingly, for example, as shown in FIG. 5, an at least approximately uniform user force F results over an adjustment path of the interior assembly 11, 12 (recorded in FIG. 5 over an adjustment angle), which can be set to a predetermined value, for example 10 N. A user must therefore apply a controlled, uniform user force of, for example, 10 N over the adjustment path of the interior assembly 11, 12 in order to bring about smooth, electric motor-assisted adjustment of the interior assembly 11, 12.

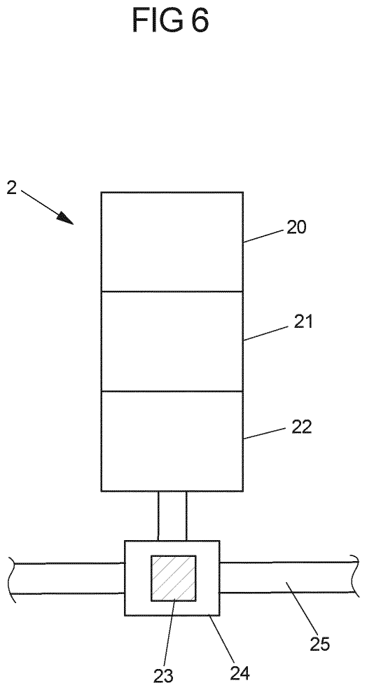

FIG. 6 schematically shows a view of an embodiment of a drive device 2, which is designed for electromotive adjustment of an associated interior assembly 11, 12 and, in particular in a servo operation, enables manual, but electromotively assisted adjustment of the associated interior assembly 11, 12.

The drive device 2 has an electromotive adjustment drive 20 in the form of an electric motor which is operatively connected to a gear unit 21. The gear 21 is used to drive an output element 23, which acts on a gear element 24 and, above it, on an adjustment assembly 25 for adjusting the associated interior assembly 11, 12.

For example, the output member 23 may be formed by a worm having worm teeth formed therein which mesh with a gear member 24 in the form of a spindle nut. The spindle nut 24 may, for example, be arranged on an adjustment assembly 25 in the form of a spindle, so that by driving the spindle nut 24 a longitudinal adjustment may be effected between the spindle nut 24 and the spindle 25 and thus an associated interior assembly 11, 12 may be longitudinally adjusted. Such an adjustment kinematics can be realized, for example, in a longitudinal adjustment device of an interior assembly 11, 12, for example in the form of a vehicle seat.

To provide a servo operation, the adjustment drive 20 with the gear 21 and the adjustment kinematics provided via the output element 23, the gear element 24 and the adjustment assembly 25 is, for example, not self-locking. An associated interior assembly 11, 12 can thus be adjusted manually while the adjustment kinematics of the drive device 2 are also moved.

In order to be able to effect a locking of the interior assembly 11, 12 in a position which has just been assumed, the drive device 2 in the embodiment shown has an inhibiting device 22 in the form of a brake which is operatively connected to the output element 23 and serves to lock the output element 23 and, above it, the associated interior assembly 11, 12 in a locked position.

If an adjustment process is initiated, in the course of which a user manually adjusts the interior assembly 11, 12 with electric motor assistance from the drive device 2, the locking device 22 is released from the locked position to an unlocked position. The locking of the interior assembly 11, 12 is thus released, so that an adjustment of the interior assembly 11, 12 can be carried out.

In principle, it should be possible for a user to adjust the interior assembly 11, 12 conveniently by a user engaging the interior assembly 11, 12 to be adjusted and moving it under manual force, the adjustment being supported by an electric motor and, in servo operation of the drive device 2, a user thus only having to apply a comparatively small adjustment force, but an adjustment force required in addition being provided by the drive device 2 in an electric-motor manner. The adjustment process is initiated when a user's desire for adjustment is detected, for example, by detecting whether a user is acting on the interior assembly 11, 12 in a way that indicates a desire for adjustment.

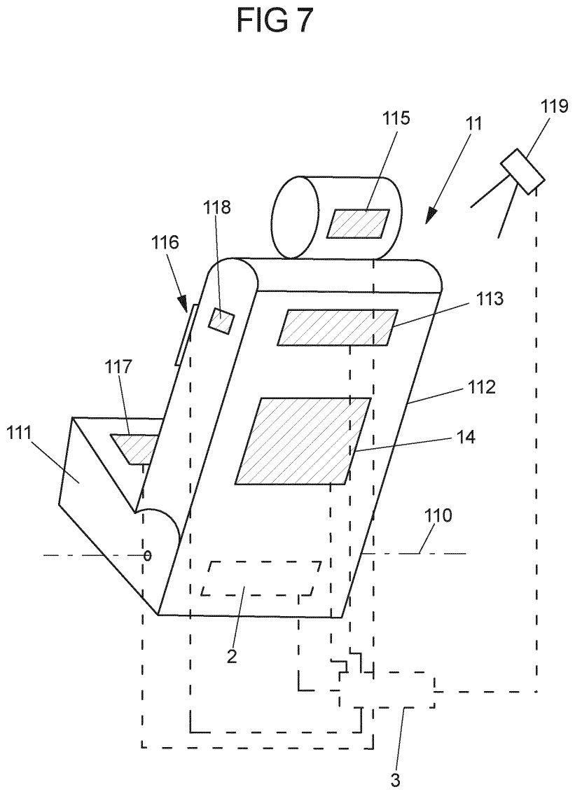

In one embodiment, the interior assembly 11, 12, as shown schematically in FIG. 7, can have an operating element 13 in the form of a button that is to be actuated by a user in order to initiate an adjustment process. Adjustment of the interior assembly 11, 12, for example of a vehicle seat, can be possible here, for example, as long as the user actuates the operating element 13 and keeps it pressed. Alternatively, the adjustment mode can be started after a single actuation, whereby the adjustment mode is automatically ended, for example, after a predetermined time or after a predetermined time following a successful adjustment action.

Additionally or alternatively, an operating element 14 in the form of a switch can be arranged, for example, centrally in the vehicle interior, for example on a center console. Actuating the operating element 14 can start an adjustment mode for one, several or all interior assemblies 11, 12, so that the interior assemblies 11, 12 can be adjusted in a servo-assisted manner.

In addition or alternatively to an operating element 13, 14, sensor devices 113-118 for detecting an adjustment request can be arranged on the interior assembly 11, as shown schematically in FIG. 7. Such sensor devices 113-118 can be designed in different ways and arranged at different locations on the interior assembly 11, 12 to be adjusted. The sensor devices 113-118 can be assigned to different subassemblies of the interior assembly 11, 12 in this case, so that an adjustment request for the interior assembly 11, 12 as a whole or a subassembly of the interior assembly 11, 12 can be detected via the sensor devices 113-118.

For example, sensor devices 113, 114, 115, 116, 117 in the form of proximity sensors or tactile touch sensors can be arranged at different locations on the backrest part 112 and/or on the seat part 111 of the interior assembly 11, 12 in the form of the vehicle seat. Via such sensor devices 113-117, it can thus be detected whether a user with a body part approaches the interior assembly 11, 12 to be adjusted and acts on the interior assembly 11, 12 in order to adjust it, if necessary.

In the example shown in FIG. 7, sensor devices 113, 114 are arranged offset in height at the rear of the backrest section 112. In contrast, a sensor device 115 is located on a headrest arranged at the upper end of the backrest section 112. A sensor device 116 is arranged at the front of the backrest section 112. A sensor device 117 is arranged on the seat part 111. All sensor devices 113-117 can be designed, for example, as proximity sensors, for example in the form of capacitive sensors, or as tactile touch sensors, it being conceivable that the sensor devices 113-117 are designed in the same way or implement different functional principles.

Detection signals of the sensor devices 113-117 can be evaluated jointly or separately. For example, if a signal is detected at the rear of the backrest section 112 via the sensor devices 113, 114, this can be interpreted as an adjustment request to swivel the backrest section 112 forward. In contrast, if a signal is detected at the sensor device 115 on the headrest, this can be interpreted as an adjustment request to adjust the headrest. If a signal is detected at the sensor device 116 arranged at the front of the backrest section 112, this can be interpreted as an adjustment request for swiveling back the backrest section 112.

The sensor device 117 can be used, for example, to detect seat occupancy by a user in order to adjust a force to be provided by the drive device 2 for servo assistance, if necessary, depending on whether an adjustment is to be made with the user on the seat or without the user.

Additionally or alternatively, a sensor device 118 in the form of an acceleration sensor or a speed sensor can be arranged on the interior assembly 11, 12 to be adjusted, with which an acceleration or an adjustment speed can be detected at the interior assembly 11, 12. If a user grips the interior assembly 11, 12 and adjusts it within the scope of the system elasticity present at the interior assembly 11, 12, this can be evaluated and used to detect a request for adjustment.

Again, in addition or alternatively, an interior monitoring device 119, for example in the form of a camera, a radar system or a lidar system, can be provided in the vehicle 1 to enable interior monitoring of the interior of the vehicle. By image-based evaluation of signals detected via the interior monitoring device 119, a user movement can be evaluated and detected in order to conclude an adjustment request.

For example, using sensor devices 113-118 and/or an interior monitoring device 119, a user gesture may be detected and interpreted as an adjustment request. For example, one or more user gestures may be predetermined that a user must perform to initiate an adjustment process for adjusting an interior assembly 11, 12. For example, such a gesture may be defined by a movement of a particular body part, for example a user's hand, with a predetermined movement pattern, for example along a particular direction of movement.

For example, such a gesture may consist of a tapping motion on a backrest portion 112 of a vehicle seat. If a user taps the backrest part 112 twice with the flat of his hand, for example, this can be interpreted as an adjustment request for advancing the vehicle seat or for pivoting the backrest part 112 forward, whereby different gestures are generally defined for different adjustment processes.

A gesture recognition may start an adjustment mode for adjusting one or more interior assemblies 11, 12, wherein multiple interior assemblies 11, 12 may be moved together. The adjustment mode may be terminated after a predetermined time, for example. Alternatively, the adjustment mode may be terminated after a predetermined time following a last adjustment action. Again alternatively, the adjustment mode may be terminated by a termination gesture to be performed by a user.

To reduce the requirements for a sensor system to detect an adjustment request and to simplify the initiation of servo operation, it may also be provided that the adjustment mode for adjusting the interior assembly 11, 12 is activated in response to one or more trigger criteria.

Such trigger criteria can be, for example, the occupancy state of an interior assembly 11, 12, for example a vehicle seat, an opening state of a vehicle door, in particular a vehicle side door or a tailgate, or a driving state of the vehicle. Such trigger criteria can be checked as positive criteria and cause the adjustment mode to be activated. However, such trigger criteria can also be checked as negative criteria (exclusion criteria) and cause the adjustment mode to be started only if such a negative criterion is not given.

For example, the opening state of a vehicle door can be queried as a positive criterion. For example, the adjustment mode can be activated when a vehicle side door or the tailgate is opened, in which case the adjustment mode is activated for an interior assembly 11, 12 in the area of the opened vehicle side door or tailgate, for example.

For example, the occupancy state or a driving state of the vehicle can be queried as a negative criterion. For example, activation of the adjustment mode can only be possible if an interior assembly 11, 12 in the form of a vehicle seat is not occupied or if the vehicle is not moving, i.e. at a standstill.

When the adjustment mode is activated in the presence of a trigger criterion or in the presence of a predetermined combination of trigger criteria, it may be provided that the inhibiting device 22 is unlocked and thus a detection of the interior assembly 11, 12, is cancelled. In addition, for example, the actuator 20 is initially energized with a low energy pulse width modulation to hold the interior assembly 11, 12 in position, for example, while compensating for a gravitational force. If a movement of the interior assembly 11, 12 is then detected, for example by means of a movement detection using Hall sensors on the interior assembly 11, 12, an adjustment request of a user is concluded and the servo operation is started, in that a further adjustment of the interior assembly 11, 12 is supported electromotively by the adjustment drive 20 in servo operation.

The current supply when the adjustment mode is activated can be low-energy in such a way that the interior assembly 11, 12 is held in position by an electric motor, but does not initially move. Alternatively, the energization can be such that the interior assembly 11, 12 is caused to move slowly when activated, and the movement can be alternating in different directions of movement by alternating energization. A value for the current flow when the adjustment mode is activated can be predefined by configuration, can be calibrated during production, or can be set adaptively at the start of each adjustment mode.

A user's adjustment request can be made by simple motion detection at the interior assembly 11, 12 when the adjustment mode is activated. Alternatively, a certain movement behavior at the interior assembly 11, 12 can be assumed and monitored for the start of the servo operation. For example, the servo operation is started when the user performs a predetermined shaking motion or a nudging motion on the interior assembly 11, 12, which is identified accordingly by the control device 3.

When the adjustment mode is activated, the control device 3 may also be configured to generate an indication signal for a user such that the user is alerted that the adjustment mode has been activated for a particular interior assembly 11, 12 and thus can be adjusted in servo operation. Such an indication may be provided by triggering the adjustment actuator 20 for a slow movement of the interior assembly 11, 12 that is perceptible by a user when the adjustment mode is activated. Alternatively, the control device 3 may provide a signal to, for example, an audio system of the vehicle to alert the user to the servo operation. Again alternatively, the control device 3 may control the actuator 20, for example, to generate a predetermined sound, for example, to play music.

A drive device 2 of the type described can be used for electric motor-assisted adjustment in servo operation in a wide variety of applications.

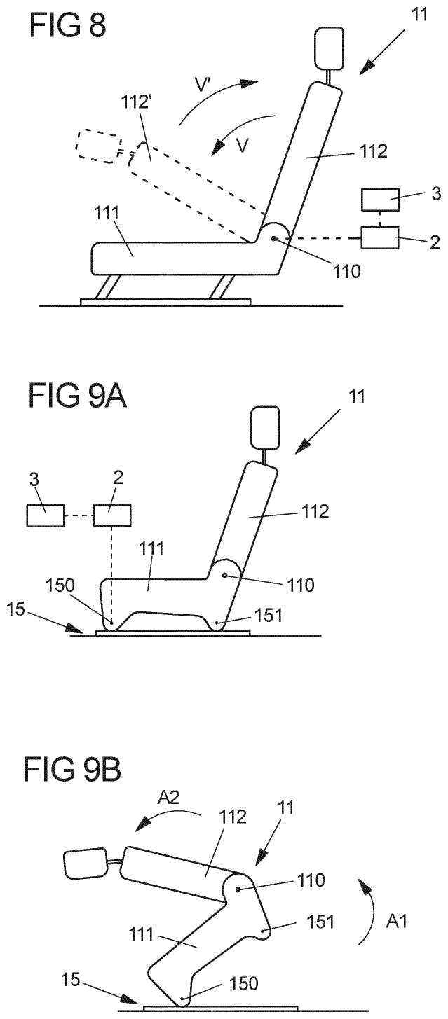

In one application, shown schematically in FIG. 8, the drive device 2 can be designed, for example, for adjusting a backrest 112 relative to a seat part 111 of a vehicle seat 11 with the assistance of an electric motor. In this case, the drive device 2 can in particular provide electromotive support for pivoting the backrest 112 about a pivot axis 110 relative to the seat part 111 in servo operation.

In this case, it can be provided that the drive device 2 supports in particular an uprighting of the backrest 112 in a swivel direction V′ from a pre-folded position 112′ (shown in FIG. 8 in dashed lines) by electric motor. In contrast, a folding forward of the backrest 112 in a swivel direction V is not supported by the drive device 2 by electric motor, for example, but is performed manually in a gravity-assisted manner.

In another application, shown in FIGS. 9A and 9B, the drive device 2 may be configured for electric motor-assisted adjustment of a vehicle seat 11 to provide an easy-entry function. The vehicle seat 11 is arranged in a normal use position, shown in FIG. 9A, on a floor assembly 15 and is locked to the floor assembly 15 via a locking device 151 in the form of an interlocking lock in the region of a rear support of the vehicle seat 11. To provide an easy-entry function, the vehicle seat 11 can be pivoted forward as a whole in a direction of movement A1, and in addition, if necessary, the backrest 112 can also be pivoted forward in a direction of movement A2 with respect to the seat part 111 as part of the easy-entry function. If access to a row of seats located behind the vehicle seat 11 is to be facilitated, a user can access the vehicle seat 11 and move it from the normal use position to an advanced position, as shown in the transition from FIG. 9A to FIG. 9B, in which, firstly, the vehicle seat 11 is pivoted as a whole about a pivot axis 150 relative to the floor assembly 15 and, in addition, the backrest 112 is moved toward the seat portion 111.

The drive device 2 can, for example, have different adjustment drives 20, each of which can be operated in servo operation. A first adjustment drive 20 can be designed, for example, for adjusting the vehicle seat 11 relative to the floor assembly 15 with the assistance of an electric motor, while a second adjustment drive is designed, for example, for adjusting the backrest 112 relative to the seat part 111 with the assistance of an electric motor.

The vehicle seat 11 and the backrest 112 can, for example, be adjustable exclusively in a coupled manner specified by a kinematic system as part of the easy entry function. Alternatively, the vehicle seat 11 as a whole and the backrest 112 can be adjusted independently of the seat part 111.

A kinematic system of the vehicle seat 11 for providing the easy-entry function can be designed, for example, as described in DE 10 2017 215 929 A1.

### DETAILED DESCRIPTION OF EMBODIMENTS

The idea underlying the disclosure is not limited to the embodiments described above, but can also be realized in other ways.

The interior assembly can be realized by quite different assemblies in the interior of a vehicle and is in this respect not limited to a vehicle seat or a console element. An interior assembly that can be adjusted via a drive device in a servo operation can also be, for example, a monitor, a shelf (for example in the form of a table or the like), a partition wall, a storage compartment or the like.

Control in servo operation is not limited to current control of the type described, but can also be designed differently.

### LIST OF REFERENCE SIGNS

1 Motor vehicle
10 Vehicle body
11 Interior assembly (vehicle seat)
110 Swivel axis
111 Seat part
112 Backrest part
113-117 Sensor device
118 Sensor device
119 Interior monitoring system
12 Interior assembly (console element)
13, 14 operating element
15 Floor assembly
150 Swivel axis
2 Drive device
20 Adjustment drive (motor)
21 Gearbox
22 Braking device (brake)
23 Drive element
24 Gear element
25 Adjustment assembly
3 Control device
30 Load calculation module
301-303 Sensoreinrichtung
31 Servo control module
310 Event detection
32 Speed control module
320 Speed input
33 Switching device
330, 331 Switching point
34 Current control module
35 PWM unit
36 Control module
α slope angle of the vehicle vertical axis
β inclination anglel of the vehicle vertical axis
ϕ door opening angle
A1, A2 Movement direction
I_{cmd} Set point
n Speed
SP center of gravity
U_{Bat} Battery voltage
x_{SP} Distance between axis of rotation and center of gravity
V Pivot direction
X Longitudinal axis of vehicle
Y Cross axis of vehicle
Z vertical axis of vehicle

1. A drive device for adjusting an interior assembly of a vehicle, comprising:
an electromotive adjustment drive for adjusting the interior assembly and a controller configured to control the adjustment drive, wherein
is the controller is further configured to control the adjustment drive in a servo operation for providing a supporting force during a manual adjustment of the interior assembly by a user.

2. The driver device of claim 1, wherein the driver device includes an inhibiting device configured to inhibit an adjusting movement of the interior assembly in a locked position, the control device being further configured to transfer the inhibiting device from the locked position to an unlocked position for adjusting the interior assembly.

3. The driver device of claim 1, wherein the driver device further includes an output element operatively connected to the adjustment drive, wherein the inhibiting device is operatively connected to the output element in order to lock the output element against adjustment in the locked position and to release it for adjustment in the unlocked position.

4. The driver device of claim 1, wherein the interior assembly is a vehicle seat or an assembly of a vehicle seat.

5. The driver device of claim 4, wherein the interior assembly is configured to be pivotable about a pivot axis or displaceable along a longitudinal direction.

6. The driver device of claim 5, wherein the interior assembly includes an operating element configured to be operable by a user to adjust the interior assembly.

7. to the driver device of claim 6, wherein the operating element is formed by a pushbutton to be actuated mechanically.

8. The driver device of claim 7, wherein the interior assembly includes a sensor configured to detect a contact, an approach, an acceleration or a movement speed at the interior assembly, wherein the controller is configured to evaluate a detection signal of the sensor to identify an adjustment request of a user.

9. The driver device of claim 8, wherein the driver device further includes a interior monitoring device, wherein the controller is further configured to evaluate a detection signal of the interior monitoring device for detecting an adjustment request of a user.

10. The driver device of claim 9, wherein the controller is further configured to evaluate a detection signal for detecting a predetermined gesture and, when the predetermined gesture is detected, conclude an adjustment request.

11. The driver device of claim 10, wherein the controller is further configured to activate an adjustment mode to adjust the interior assembly in servo operation as a function of at least one trigger criterion.

12. The driver device of claim 11, wherein the controller is further configured to evaluate as a trigger criterion an occupancy state of the interior assembly, an opening state of a vehicle door, or a driving state of the vehicle.

13. The driver device of claim 12, wherein the controller is further configured to drive the adjustment drive with a pulse-width modulated current signal upon or after activation of the adjustment mode.

14. The driver device of claim 13, wherein the controller is further configured to adapt to control the adjustment drive in the adjustment mode for providing a supporting force in a manual adjustment of the interior assembly by a user in response to an adjustment request of a user is detected after activating the adjustment mode.

15. The driver device of claim 14, wherein the controller is further configured to generate an indication signal as an indication of the adjustment mode for output to a user after activation of the adjustment mode.

16. The driver device of claim 15, wherein the controller includes a servo controller configured to determine a setpoint in dependence on a load acting on the interior assembly.

17. The drive device of claim 16, wherein the controller includes a current controller configured to control a current of the adjustment drive, wherein the current controller is further configured to adapt to control the current of the adjustment drive based on the setpoint supplied by the servo controller.

18. The driver device of claim 16, wherein the controller includes a load calculation configured to calculate a load acting on the interior assembly as a function of an angle of inclination of the vehicle measured about a vehicle longitudinal axis (X), an angle of inclination of a pivot axis of the interior assembly measured about the vehicle longitudinal axis (X), an angle of inclination of the vehicle measured about a vehicle transverse axis (Y), an angle of inclination of the pivot axis of the interior assembly measured about the vehicle transverse axis (Y), or a position of the interior assembly.

19. The driver device of claim 18, wherein the servo controller is further configured to determine a target force to be provided by the adjustment drive on the basis of a load acting on the interior assembly and a target force value to be applied by a user.

20. The driver device of claim 19, wherein the load acting on the interior assembly is determined by utilizing a static load force acting on the interior assembly and a dynamic load force acting on the interior assembly.

21. The driver device of claim 20, wherein the target force is determined by a force balance of the static load force, the dynamic load force and a user force resulting from the target force value to
Fₛₑₜ=Fₛₜₐₜ+F_{dyn}−Fᵤₛₑᵣ,
where Fₛₑₜ is the nominal force, Fₛₜₐₜ is the static load force, F_{dyn} is the dynamic load force, and Fᵤₛₑᵣ is the user force.

22. to the driver device of claim 21, wherein the servo-controller is configured to determine the setpoint value on the basis of the setpoint force to be provided by the adjustment drive.

23. The driver device of claim 22, wherein the current controller is configured to adjust the current of the adjustment drive using pulse width modulation.

24. A drive device according to claim 23, wherein the current control module is designed to control the current of the adjustment drive on the basis of the supplied setpoint value and the resulting actual motor current.
